(19) United States
(12) Patent Application Publication
(10) Pub. No.: US 2025/0292594 A1
(43) Pub. Date: Sep. 18, 2025

(54) DRIVING ASSISTANCE APPARATUS

(71) Applicant: SUBARU CORPORATION, Tokyo (JP)

(72) Inventor: Tomoya TAKEUCHI, Tokyo (JP)

(73) Assignee: SUBARU CORPORATION, Tokyo (JP)

(21) Appl. No.: 19/049,126

(22) Filed: Feb. 10, 2025

(30) Foreign Application Priority Data
Mar. 18, 2024 (JP) 2024-041795

(51) Int. Cl. G06V 20/56; G01C 21/00; G06V 20/58

(52) U.S. Cl. CPC G06V 20/588; G01C 21/3822; G01C 21/3841; G06V 20/58; G06V 2201/08

(57) ABSTRACT

A driving assistance apparatus is configured to be applied to a vehicle and includes an imager, laser light emitters in a right and left pair, and a processor. The imager is configured to capture an image of a front of the vehicle. The laser light emitters are provided in a width direction of the vehicle, and configured to emit respective pieces of laser light from the vehicle to a road surface in front of the vehicle. The processor is configured to detect, based on the image captured by the imager, lane lines and ruts, and operate the laser light emitters. The processor is configured to operate the laser light emitters and cause the respective pieces of laser light to be applied toward the ruts, when the lane lines are not detected by the processor and the ruts are detected by the processor.

### CROSS-REFERENCE TO RELATED APPLICATIONS

The present application claims priority from Japanese Patent Application No. 2024-041795 filed on Mar. 18, 2024, the entire contents of which are hereby incorporated by reference.

### BACKGROUND

The disclosure relates to a driving assistance apparatus.

For example, Japanese Unexamined Patent Application Publication (JP-A) No 2013-91494 discloses a driving assistance apparatus for a vehicle, such as automobile, which suppresses a deviation from a traveling lane of the vehicle. The driving assistance apparatus has a controller that detects lane lines that define a traveling lane, based on an image captured by an imaging device such as a camera. When the controller predicts that the vehicle can deviate from the lane line based on the detected lane lines, the controller suppresses the deviation of the vehicle from the traveling lane by causing an operation torque to be applied to a steering mechanism.

### SUMMARY

An aspect of the disclosure provides a driving assistance apparatus to configured be applied to a vehicle. The driving assistance apparatus includes an imager, laser light emitters in a right and left pair, and a processor. The imager is configured to capture an image of a front of the vehicle. The laser light emitters are provided in a width direction of the vehicle, and configured to emit respective pieces of laser light from the vehicle to a road surface in front of the vehicle. The processor is configured to detect, based on the image captured by the imager, lane lines and ruts, and operate the laser light emitters, in which the lane lines define a lane in which the vehicle is to travel. The processor is configured to operate the laser light emitters and cause the respective pieces of laser light to be applied toward the ruts, when the lane lines are not detected by the processor and the ruts are detected by the processor.

An aspect of the disclosure provides a driving assistance apparatus configured to be applied to a vehicle. The driving assistance apparatus includes an imager, laser light emitters, and a processor. The imager is configured to capture an image of a front of the vehicle. The laser light emitters are configured to emit respective pieces of laser light from the vehicle to a road surface in front of the vehicle. The processor is configured to detect, based on the image captured by the imager, lane lines and ruts, and operate the laser light emitters, in which the lane lines define a lane in which the vehicle is to travel. The processor is configured to operate one or both of the laser light emitters and cause one or both of the pieces of laser light to be applied toward one or both of the ruts, when one or both of the lane lines are not detected by the processor and the one or both of the ruts are detected by the processor.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a plan diagram illustrating a vehicle to which a driving assistance apparatus according to one example embodiment of the disclosure is applied, as viewed from an upper side of the vehicle.

FIG. 2 is a block diagram illustrating the driving assistance apparatus according to one example embodiment of the disclosure.

FIG. 3 is a plan diagram illustrating an example of pieces of laser light applied to a road surface from respective laser light emitters illustrated in FIG. 1.

FIG. 4 is a plan diagram illustrating another example of the pieces of laser light applied to the road surface from the respective laser light emitters illustrated in FIG. 1.

FIG. 5 is a flowchart illustrating an example of an operation of the driving assistance apparatus illustrated in FIG. 1.

### DETAILED DESCRIPTION

A driving assistance apparatus disclosed in JP-A No 2013-91494 has room for improvement in that the driving assistance apparatus can suffer from difficulties in activating a lane departure suppressing function, in an example case where a controller involves difficulties in detecting lane lines due to a condition such as snow accumulation on a road. In this case, a driving assistance becomes insufficient, which can decrease convenience to a driver who drives a vehicle.

It is desirable to provide a driving assistance apparatus that makes it possible to improve convenience to a driver who drives a vehicle.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

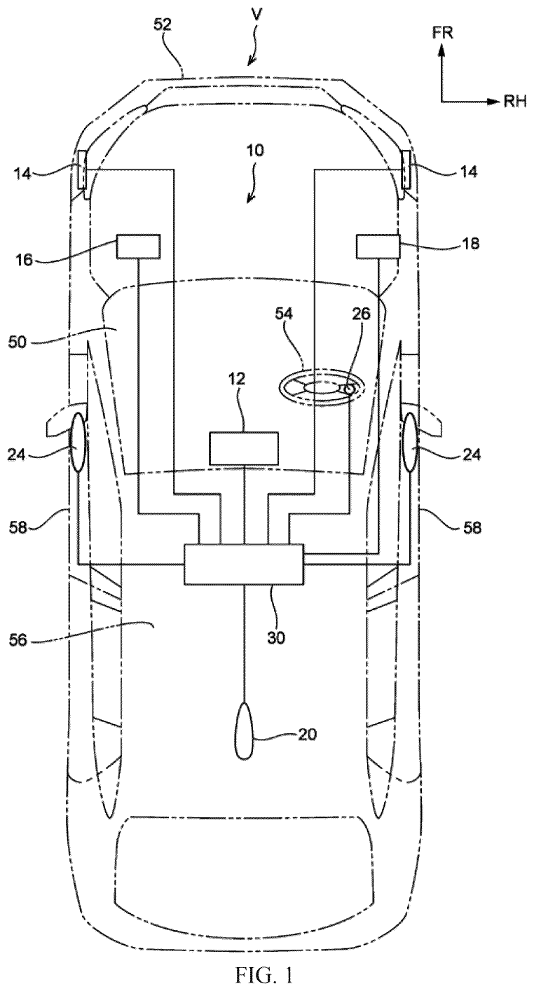

Hereinafter, a vehicle V to which a driving assistance apparatus 10 according to an example embodiment is applied will be described with reference to the drawings. In some embodiments, the vehicle V may be an automobile. Note that an arrow FR illustrated in FIG. 1 indicates a front side of the vehicle V, and an arrow RH indicates a right side (i.e., one side in a vehicle width direction) of the vehicle V when viewed from an upper side of the vehicle V.

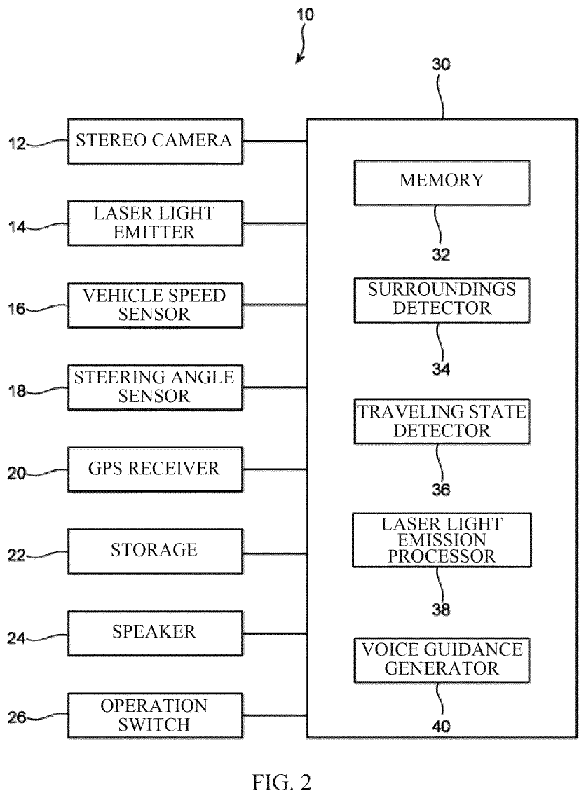

Referring to FIGS. 1 and 2, the driving assistance apparatus 10 includes a stereo camera 12, a pair of right and left laser light emitters 14, and a processor 30. The driving assistance apparatus 10 may further include a vehicle speed sensor 16, a steering angle sensor 18, a GPS receiver 20, a storage 22, a speaker 24, and an operation switch 26.

In one embodiment, the stereo camera 12 may serve as an “imager”. In one embodiment, the speaker 24 may serve as a “notifier”.

Hereinafter, each configuration of the driving assistance apparatus 10 will be described.

### Stereo Camera 12

The stereo camera 12 may be provided at the middle in the vehicle width direction at an upper end of a windshield 50 of the vehicle V. The stereo camera 12 captures an image of the front of the vehicle V, and may output captured image data to a later-described surroundings detector 34 of the processor 30.

### Laser Light Emitters 14

The laser light emitters 14 may be provided, for example, at both ends in the vehicle width direction of a bumper cover 52 that configures a front end part of the vehicle V. The laser light emitter 14 may include: a body having a laser oscillator; and a support that supports the body. The laser light emitter 14 may be electrically coupled to a later-described laser light emission processor 38 of the processor 30. The laser light emitter 14 may operate under a control of the laser light emission processor 38, and applies laser light toward a road surface on a front side of the vehicle V. The support of the laser light emitter 14 may have an actuator. The actuator may drive the body to change an attitude of the body and thereby change an emission direction of the laser light. For example, the actuator may change the emission direction of the laser light to an up-down direction and a right-left direction of the vehicle V.

### Vehicle Speed Sensor 16 and Steering Angle Sensor 18

The vehicle speed sensor 16 may detect a rotational speed of an output shaft of the vehicle V, and output a detection signal to a later-described traveling state detector 36 of the processor 30. The steering angle sensor 18 may detect a steering angle of a steering wheel 54 of the vehicle V and output a detection signal to the traveling state detector 36.

### GPS Receiver 20

The GPS receiver 20 may be provided on a roof 56 of the vehicle V. The GPS receiver 20 may receive signals from GPS satellites and measure a current position of the vehicle V. The GPS receiver 20 may output data on the current position of the vehicle V thus measured to the later-described traveling state detector 36 of the processor 30.

### Storage 22

The storage 22 may have devices including, for example, a read-only memory (ROM) and a random-access memory (RAM). The storage 22 may store data such as map data. The map data may include data such as road position data or road attribute data. Non-limiting examples of the road attribute data may include data on a speed limit of the road, data on a curve radius of the road, and a gradient inclination angle of the road.

### Speaker 24

The speaker 24 may be built in a side door 58 that configures a side surface of the vehicle V. As will be described in detail later, the driving assistance apparatus 10 may notify a driver who drives the vehicle V of information on a driving operation by voice from the speaker 24.

### Operation Switch 26

The operation switch 26 may be operably provided on the steering wheel 54 of the vehicle V. The operation switch 26 may be electrically coupled to the later-described processor 30, and output, to the processor 30, an output signal corresponding to an operation. The processor 30 may start or stop an operation of the driving assistance apparatus 10, based on the output signal from the operation switch 26.

### Processor 30

The processor 30 may include a memory 32, the surroundings detector 34, the traveling state detector 36, the laser light emission processor 38, and a voice guidance generator 40. In some embodiments, the processor 30 may be an electronic control unit (ECU).

The memory 32 may have devices including, for example, a ROM and a RAM. The memory 32 may store various pieces of data such as a control program.

The surroundings detector 34 may detect the surroundings of the vehicle V on the front side, based on the captured image data outputted from the stereo camera 12. For example, the surroundings detector 34 may process the captured image data outputted from the stereo camera 12 and determine whether the lane lines of the lane in which the vehicle V is to travel are detectable. The surroundings detector 34 may determine whether ruts of the lane in which the vehicle V is to travel are detectable. In some embodiments, the surroundings detector 34 may determine whether a front vehicle on the front side of the vehicle V is detectable. The surroundings detector 34 may calculate a factor such as an inter-vehicle distance between the vehicle V and the front vehicle or a relative speed between the vehicle V and the front vehicle, when the front vehicle is detected.

The traveling state detector 36 may detect a traveling state of the vehicle V. For example, the traveling state detector 36 may calculate a traveling speed of the vehicle V, based on data outputted from the vehicle speed sensor 16. The traveling state detector 36 may predict a traveling direction of the vehicle V, based on data outputted from the steering angle sensor 18.

The laser light emission processor 38 may control an operation of the laser light emitters 14, based on a detection result of the surroundings detector 34. Upon the operation of the laser light emitters 14, the laser light emitters 14 may be so operated that pieces of laser light LL emitted from the laser light emitters 14 to the front side of the vehicle V are flashed on the road surface in front of the vehicle V. This configuration helps to allow the driver to recognize respective positions on both ends in the vehicle width direction of the vehicle V by the pair of right and left laser light LL flashing on the road surface.

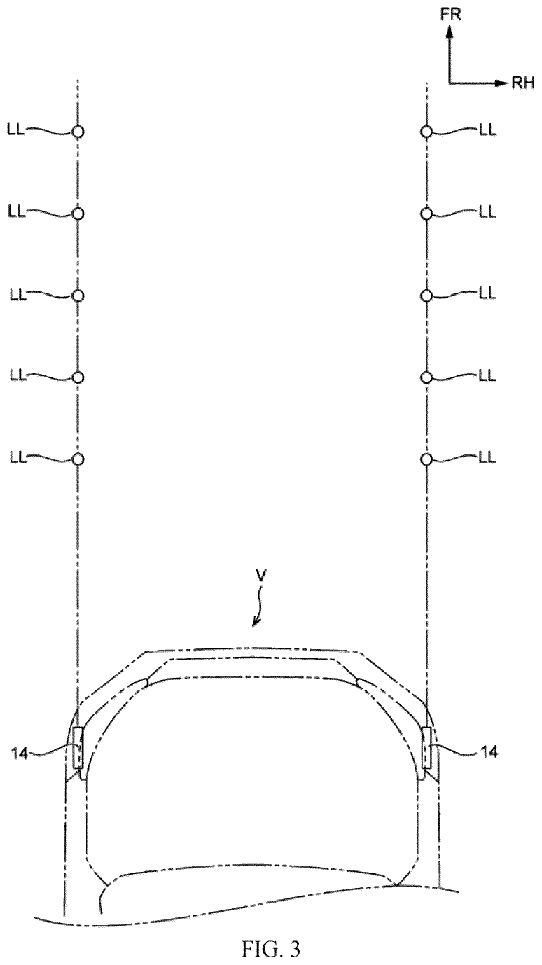

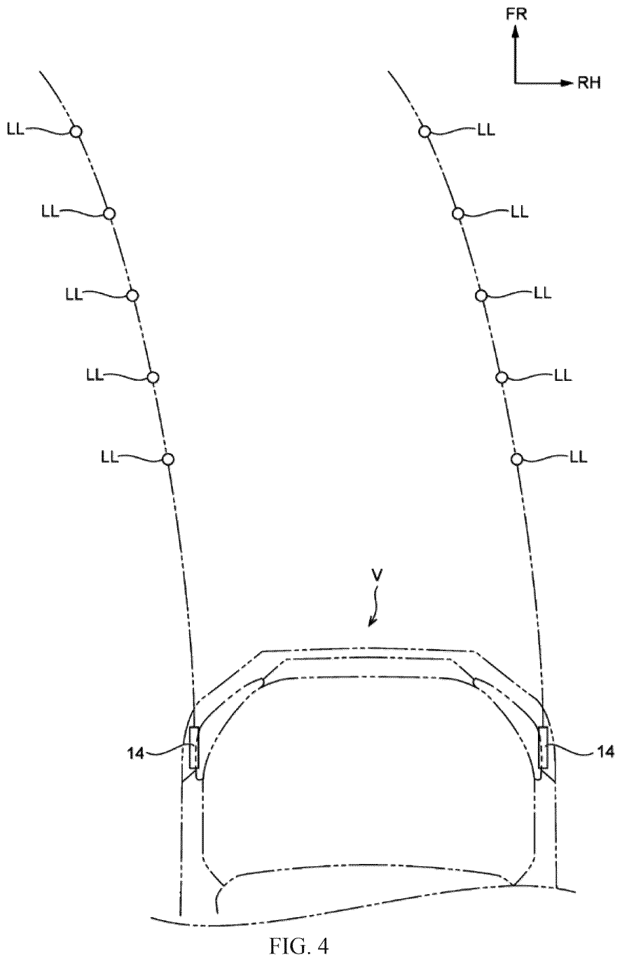

In some embodiments, upon the operation of the laser light emitters 14, the laser light emission processor 38 may so control the operation of the laser light emitters 14 that the pieces of laser light LL flashing on the road surface move in the traveling direction of the vehicle V. For example, the laser light emission processor 38 may drive the actuators of the respective laser light emitters 14 to change emission directions of the respective pieces of laser light LL, based on the traveling direction predicted by the traveling state detector 36. In one example, when the vehicle Vis predicted to travel straight, the bodies of the respective laser light emitters 14 may be moved in the up-down direction of the vehicle V, causing the pieces of laser light LL flashing on the road surface to be moved linearly and intermittently toward the front side of the vehicle V when viewed from the upper side of the vehicle V, as illustrated in FIG. 3. In one example, as illustrated in FIG. 4, when the vehicle V is predicted to curve to the left, the bodies of the respective laser light emitters 14 may be moved in the up-down direction and the right-left direction of the vehicle V, causing the pieces of laser light LL flashing on the road surface to be moved intermittently to the left side of the vehicle V as the vehicle V travels toward the front of the vehicle V as viewed from the upper side of the vehicle V.

As will be described in detail later, when the surroundings detector 34 detects the ruts in front of the vehicle V, the laser light emission processor 38 may so operate the laser light emitters 14 that the pieces of laser light LL emitted from the respective laser light emitters 14 are applied toward the ruts. For example, the laser light emission processor 38 may so operate the laser light emitters 14 as to apply the pieces of laser light LL emitted from the laser light emitters 14 toward respective positions spaced apart from the ruts by a predetermined distance on an outer side in the vehicle width direction. The predetermined distance may be 10 cm, although it is not limited thereto.

The voice guidance generator 40 may generate voice guidance data on the driving operation, and output the voice guidance data to the speaker 24. For example, the voice guidance generator 40 may acquire a position of the vehicle V and the road attribution data on the road along which the vehicle V is traveling, based on the position data determined by the GPS receiver 20. The voice guidance generator 40 may acquire the traveling speed of the vehicle V from the traveling state detector 36. The voice guidance generator 40 may acquire data on a factor such as the inter-vehicle distance between the vehicle V and the front vehicle from the surroundings detector 34. The voice guidance generator 40 may generate the voice guidance data on the driving operation from the acquired pieces of data, and output the voice guidance data to the speaker 24.

For example, the voice guidance generator 40 may generate the voice guidance data that prompts the driver to drive at a speed limit, such as “please drive at a speed limit of XX Km/h” or the voice guidance data that indicates that the driver has exceeded the speed limit, such as “the vehicle V exceeds the speed limit of XX Km/h by 10 km/h”. The voice guidance generator 40 may output the thus-generated voice guidance data to the speaker 24. The voice guidance generator 40 may generate the voice guidance data that prompts the driver to drive with the front vehicle as a mark, such as “please drive with the front vehicle as a mark”, “the vehicle V is traveling close to the front vehicle”, or “the vehicle V is traveling away from the front vehicle”. The voice guidance generator 40 may output the thus-generated voice guidance data to the speaker 24. The voice guidance generator 40 may generate voice guidance data that prompts the driver to give attention that is based on the road attribute data, such as “there is a gentle left curve ahead”, “there is a steep left curve ahead”, “there is a gentle right curve ahead”, or “there is a steep right curve ahead”. The voice guidance generator 40 may output the thus-generated voice guidance data to the speaker 24.

In the driving assistance apparatus 10, the processor 30 may control an operation angle of the steering wheel 54 of the vehicle V to execute a driving assistance that prevents the vehicle V from deviating from the lane lines, when the processor 30 detects the lane lines of the lane. In this case, a display mounted on the vehicle V may display information that the driving assistance of the lane departure suppression by the driving assistance apparatus 10 is in execution.

### Workings and Example Effects

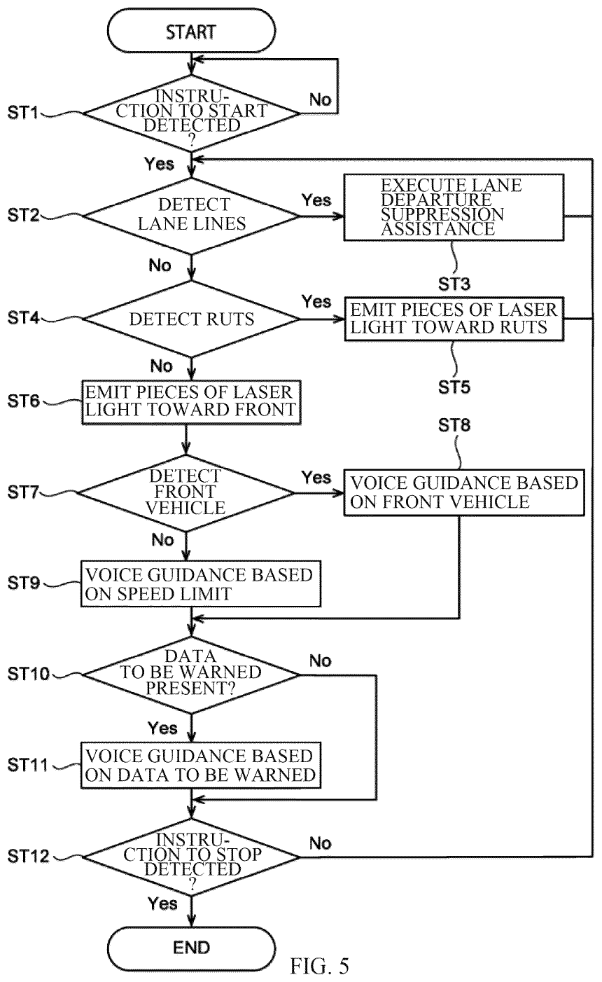

Next, workings and some example effects of the example embodiment will be described while the operation of the driving assistance apparatus 10 is described with reference to a flowchart illustrated in FIG. 5.

In an operation of the driving assistance apparatus 10, in Step 1, the processor 30 may detect an instruction to start the driving assistance apparatus 10, based on the output signal from the operation switch 26 (ST1). In Step 1, if the instruction to start the driving assistance apparatus 10 is not detected (“No” in Step 1), the process may return to Step 1. In Step 1, if the instruction to start the driving assistance apparatus 10 is detected (“Yes” in Step 1), the process may proceed to Step 2 (ST2).

In Step 2, the surroundings detector 34 may determine whether the lane lines of the lane in which the vehicle V is traveling are detectable. In some embodiments, the surroundings detector 34 may determine whether the lane lines of the road surface are not covered by a factor such as snow accumulation on the road surface. If the surroundings detector 34 detects the lane lines (“Yes” in Step 2), the process may proceed to Step 3 (ST3).

In Step 3, the driving assistance apparatus 10 may execute the driving assistance to prevent the vehicle V from deviating from the lane, by controlling the operation angle of the steering wheel 54 of the vehicle V. For example, the driving assistance apparatus 10 may perform the driving assistance for a purpose of suppressing the lane departure, based on the detected lane lines. After the process of Step 3, the process may return to Step 2.

In Step 2, if the surroundings detector 34 involves difficulty in detecting the lane lines (“No” in Step 2), the process may proceed to Step 4 (ST4).

In Step 4, the surroundings detector 34 may determine whether the ruts in front of the vehicle V are detected. If the ruts are detected by the surroundings detector 34 (“Yes” in Step 4), the process may proceed to Step 5 (ST5).

In Step 5, the laser light emission processor 38 may cause the laser light emitters 14 to operate and the pieces of laser light LL emitted from the respective laser light emitters 14 may be applied toward the ruts. For example, the pieces of laser light LL emitted from the laser light emitters 14 may be emitted toward respective positions 10 cm away from the ruts on the outer side in the vehicle width direction. This helps to allow the driver to recognize the positions to which the pieces of laser light LL are applied as the respective position of the lane lines and drive the vehicle V. In other words, when the lane lines are not detected and the ruts are detected, the driving assistance for the driver may be performed by forming imaginary lane lines based on the respective ruts in front of the vehicle V by the pieces of laser light LL. After the process of step 5, the process may return to Step 2.

In Step 4, if the surroundings detector 34 involves difficulties in detecting the ruts (“No” in Step 4), the process may proceed to Step 6 (ST6).

In Step 6, the laser light emission processor 38 may cause the laser light emitters 14 to operate and the pieces of laser light LL may be emitted from the both ends of the vehicle V in the vehicle width direction toward the front side of the vehicle V. Thus, the pieces of laser light LL emitted from the respective laser light emitters 14 may be flashed on the road surface at respective positions corresponding to the both ends of the vehicle V in the vehicle width direction. This helps to allow the driver to perform the driving, based on the pieces of laser light LL emitted forward as marks. In Step 6, based on the traveling direction predicted by the traveling state detector 36, the laser light emission processor 38 may drive and control the actuators of the respective laser light emitters 14 to change the emission directions of the pieces of laser light LL. In other words, when the lane lines and the ruts are not detected, the driving assistance for the driver may be performed by forming the imaginary lane lines based on the traveling direction of the vehicle V by the pieces of laser light LL. After the process of Step 6, the process may proceed to Step 7 (ST7).

In Step 7, the surroundings detector 34 may determine whether the front vehicle in front of the vehicle V is detected. If the front vehicle is detected by the surroundings detector 34 (“Yes” in Step 7), the process may proceed to Step 8 (ST8).

In Step 8, the voice guidance generator 40 may generate the voice guidance data that prompts the driver to perform the driving with the front vehicle as the mark, and output the voice guidance data to the speaker 24. Thus, voice such as “please drive with the front vehicle as a mark”, “the vehicle V is traveling close to the front vehicle”, or “the vehicle V is traveling away from the front vehicle” is outputted from the speaker 24. In other words, the driving assistance by voice based on the front vehicle may be performed.

In Step 8, when, for example, the traveling speed of the vehicle V is 10 Km/h over the speed limit, the voice guidance generator 40 may generate the voice guidance data that prompts the driver to drive at the speed limit, and output the voice guidance data to the speaker 24. For example, voice such as “the vehicle V exceeds the speed limit by 10 Km/h. Drive at the speed limit of XX Km/h without following the front vehicle” is outputted from the speaker 24. This helps to prompt the driver to drive at the speed limit. After the process of Step 8, the process may proceed to Step 10 (ST10).

In Step 7, if the surroundings detector 34 involves difficulty in detecting the front vehicle (“No” in Step 7), the process may proceed to Step 9 (ST9).

In Step 9, the voice guidance generator 40 may generate the voice guidance data that prompts the driver to drive at the speed limit, and output the voice guidance data to the speaker 24. For example, voice such as “drive at a speed limit of XX Km/h” or “the vehicle V exceeds the speed limit of XX Km/h by 10 Km/h” is outputted from the speaker 24. Thus, the driving assistance by voice based on the speed limit may be performed when there is no front vehicle. After the process of Step 9, the process may proceed to Step 10 (ST10).

In Step 10, the voice guidance generator 40 may determine whether there is the road attribute data to be warned to the driver on the traveling road. In Step 10, if there is the road attribute data to be notified (“Yes” in Step 10), the process may proceed to Step 11 (ST11).

In Step 11, the voice guidance generator 40 may generate, based on the road attribute data of the map data, the voice guidance data to be warned about the driving operation, and output the thus-generated voice guidance data to the speaker 24. For example, voice such as “there is a gentle left curve ahead”, “there is a steep left curve ahead”, “there is a gentle right curve ahead”, or “there is a steep right curve ahead” may be outputted from the speaker 24. After the process of Step 11, the process may proceed to Step 12 (ST12). In Step 10, when there is no road attribute data to be warned (“No” in Step 10), the process may proceed to Step 12 as well.

In Step 12, the processor 30 may detect an instruction to stop the driving assistance apparatus 10, based on the output signal from the operation switch 26. In Step 12, if the instruction to stop the driving assistance apparatus 10 is not detected (“No” in Step 12), the process may return to Step 2. In step 12, if the instruction to stop the driving assistance apparatus 10 is detected (“Yes” in Step 12), the operation of the driving assistance apparatus 10 may be stopped.

The driving assistance apparatus 10 according to the example embodiment includes the pair of right and left laser light emitters 14. The surroundings detector 34 of the processor 30 detects the lane lines that define the lane in which the vehicle V is to travel and the ruts, based on the data on the image captured by the stereo camera 12. When the processor 30 involves difficulty in detecting the lane lines and detects the ruts, the laser light emission processor 38 of the processor 30 operates the laser light emitters 14 to cause the pieces of laser light LL to be applied toward the respective ruts. This forms the imaginary lane lines by the respective pieces of laser light LL based on the ruts, which helps to perform the driving assistance based on the imaginary lane lines as the marks even when it is difficult to perform the driving assistance based on the lane lines. This configuration helps to improve convenience to the driver.

In some embodiments, when the surroundings detector 34 of the processor 30 involves difficulty in detecting the ruts and detects the front vehicle, the voice guidance generator 40 of the processor 30 may generate the voice information on the driving operation based on the inter-vehicle distance with respect to the front vehicle or the traveling speed, and output the thus-generated information from the speaker 24. For example, the voice guidance generator 40 may generate the voice guidance data that prompts the driver to drive with the front vehicle as the mark, and output the voice guidance data to the speaker 24. The voice guidance generator 40 may generate the voice guidance data that prompts the driver to drive based on the speed limit, and output the voice guidance data to the speaker 24. This configuration helps to perform the driving assistance for the driver by providing the driver with the voice guidance on the driving based on the front vehicle, even when the processor 30 involves difficulty in detecting the lane lines and the ruts.

In some embodiments, when the surroundings detector 34 of the processor 30 involves difficulty in detecting the ruts, the laser light emission processor 38 may operate the laser light emitters 14 to cause the pieces of laser light LL applied on the road surface to be moved in the traveling direction of the vehicle V. In some embodiments, the emission directions of the respective pieces of laser light LL may be changed, based on the steering angle of the steering wheel 54 of the vehicle V. This configuration helps to perform the driving assistance for the driver by forming the imaginary lane lines that are based on the traveling direction of the vehicle V in front of the vehicle V by the pieces of laser light LL, even when the processor 30 involves difficulty in detecting the lane lines and the ruts.

In some embodiments, when the surroundings detector 34 of the processor 30 involves difficulty in detecting the front vehicle, the voice guidance generator 40 of the processor 30 may generate data on the driving operation based on the speed limit data of the road, and output the data on the driving operation to the speaker 24. This configuration helps to provide the driver with the imaginary lane lines formed by the respective pieces of laser light LL as the marks while information on the speed limit is provided to the driver by voice, even when the front vehicle is not detected.

In some embodiments, the processor 30 may be configured to operate one or both of the laser light emitters 14 and cause one or both of the pieces of laser light LL to be applied toward one or both of the ruts, when one or both of the lane lines are not detected by the processor 30 and the one or both of the ruts are detected by the processor 30. This forms one or more imaginary lane lines by one or both pieces of laser light LL based on one or both of the ruts, which helps to perform the driving assistance based on the one or more imaginary lane lines as the marks even when it is difficult to perform the driving assistance based on the lane lines. This configuration helps to improve convenience to the driver.

Although some example embodiments of the disclosure are described in detail with reference to the drawings, any vehicle appropriately modifiable by a person skilled in the art based on the vehicle described above in any of the example embodiments and their modification examples of the disclosure also falls within the scope of the disclosure as long as it encompasses the inventive concept of the disclosure.

It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

For example, any process, machine, manufacture, or composition of matter in which a person skilled in the art has made addition of any element, deletion of any element, or change in design to any of the example embodiments and their modification examples described above falls within the scope of the disclosure as long as it encompasses the inventive concept of the disclosure.

Further, any working and effect apparent from the disclosure or conceivable by a person skilled in the art from the disclosure shall be construed as those that belong to the disclosure as any other working and effect achievable by any of the example embodiments and their modification examples of the disclosure.

Various technologies may be formed by appropriately combining multiple elements disclosed in any of the example embodiments and their modification examples of the disclosure.

For example, one or more elements may be deleted from all the elements described in any of the example embodiments and their modification examples of the disclosure.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

The processor 30 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the processor 30. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the processor illustrated in FIG. 1.

1. A driving assistance apparatus configured to be applied to a vehicle, the driving assistance apparatus comprising:
an imager configured to capture an image of a front of the vehicle;
laser light emitters in a right and left pair provided in a width direction of the vehicle, the laser light emitters being configured to emit respective pieces of laser light from the vehicle to a road surface in front of the vehicle; and
a processor configured to detect, based on the image captured by the imager, lane lines and ruts, and operate the laser light emitters, the lane lines defining a lane in which the vehicle is to travel, wherein
the processor is configured to operate the laser light emitters and cause the respective pieces of laser light to be applied toward the ruts, when the lane lines are not detected by the processor and the ruts are detected by the processor.

2. The driving assistance apparatus according to claim 1, further comprising a notifier configured to notify information on a driving operation, wherein
the processor is configured to detect, based on the image captured by the imager, a front vehicle in front of the vehicle, and calculate an inter-vehicle distance between the vehicle and the front vehicle and a traveling speed of the vehicle, and
the processor is configured to cause the notifier to notify the information that is based on the inter-vehicle distance calculated by the processor or the traveling speed calculated by the processor, when the ruts are not detected by the processor and the front vehicle is detected by the processor.

3. The driving assistance apparatus according to claim 2, wherein the processor is configured to operate the laser light emitters and move the respective pieces of laser light applied to the road surface in a traveling direction of the vehicle, and to change, based on a steering angle of a steering wheel of the vehicle, emission directions of the respective pieces of laser light.

4. The driving assistance apparatus according to claim 2, further comprising a storage configured to store map data that comprises speed limit data of a road, wherein
the processor is configured to cause the notifier to notify the information that is based on the speed limit data, when the front vehicle is not detected by the processor.

5. A driving assistance apparatus configured to be applied to a vehicle, the driving assistance apparatus comprising:
a camera configured to capture an image of a front of the vehicle;
laser light emitters configured to emit respective pieces of laser light from the vehicle to a road surface in front of the vehicle; and
a processor configured to detect, based on the image captured by the camera, lane lines and ruts, and operate the laser light emitters, the lane lines defining a lane in which the vehicle is to travel, wherein
the processor is configured to operate one or both of the laser light emitters and cause one or both of the pieces of laser light to be applied toward one or both of the ruts, when one or both of the lane lines are not detected by the processor and the one or both of the ruts are detected by the processor.
